(19) United States
(12) Patent Application Publication
(10) Pub. No.: US 2006/0047819 A1
(43) Pub. Date: Mar. 2, 2006

(54) Simultaneous transfer of database updates between multiple clients and a server

(76) Inventors: Scott Allen Caddes, Sandy, UT (US); R. Kenin Page, Sandy, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/052,977

(22) Filed: Feb. 7, 2005

Related U.S. Application Data
(60) Provisional application No. 60/571,676, filed on May 14, 2004.

(51) Int. Cl. G06F 15/16

(52) U.S. Cl. 709/227

(57) ABSTRACT

The present invention relates to simultaneous transfer of database updates between multiple clients and a server. A plurality of (potentially limited resource) clients simultaneously establishes (e.g., TCP) connections to a server. Database updates are efficiently transferred between the server and each of the plurality of clients simultaneously. Server resources are utilized at the server to resolve any data conflicts such that the limited resources (e.g., system memory) of any clients are conserved. Clients that receive database updates overwrite existing client database with the received database updates. In preparation for receiving a database update, clients can empty a client database such that a received database update is more efficiently written into the client database.

### CROSS-REFERENCE TO RELATED APPLICATIONS

The present application claims priority to U.S. Provisional Patent Application Ser. No. 60/571,676 entitled “Method For Multiple Simultaneous Remote Computer Device Clients To Transfer Databases To and From A Server”, filed May 14, 2004, which is hereby incorporated by reference in its entirety.

### BACKGROUND OF THE INVENTION

1. The Field of the Invention

The present invention generally relates to exchanging data between computer systems. More specifically, the present invention relates to simultaneous transfer of database updates between multiple clients and a server.

2. The Relevant Technology

With advances in technology, individuals and business organizations continually seek to obtain and achieve automated solutions to fulfilling their various needs, such as manipulation of business data, transmission of data between various locations, and the like. One such advance is the computer network that allows numerous users to connect or interface one with another.

Unfortunately, typical computer networks require each computer to be physically connected one to another thereby limiting the usefulness and access to the computer network by those individuals who are distant from or working away from the computer network. This is especially evident with respect to the increase of usage of personal digital assistants or hand held computers (collectively “PDAs”), such as computers, organizers, wireless telephones, and the like.

Since both individuals and organizations desire access to a computer network via PDAs, it is necessary for each PDA to communicate and interface with existing software applications and hardware devices. It is especially important that data gathered and updated in a database on a PDA client can be efficiently transmitted to a main database stored on a server. Likewise, once data from one or more PDA databases is transmitted to the main database on the server, it is important that the corresponding database on each PDA be efficiently updated with any data that may have changed on the server database.

Data transmission between a client database and a server database typically involves synchronization. Synchronization typically includes utilizing system resources to compare the data stored on the client and the server databases. This requires that memory on both the client and the server is utilized in order to temporarily store data values from the client and the server and also that processing power be utilized to compare the data values in order to synchronize the data according to some criteria. For example, when data from the server and the client is compared and the data is not the same, the synchronization criteria may dictate that the most recently changed data be copied to both databases, or that the data from the database with the highest priority be copied to both databases.

However, because of comparatively limited memory and processing resources of PDA clients, current implementations that utilize synchronization between the PDA client database and the main server database are (sometimes extremely) slow. The temporary storage of data in memory and comparisons of data can be quite burdensome to a PDA client having limited memory and processing power.

Furthermore, at least one current technology does not allow multiple PDA clients to simultaneously connect to the server in order transmit data. Additionally, some current implementations of database transmission methods do not allow extremely large amounts of data or numbers of records to be transmitted from a PDA client database to a server database. Therefore, mechanisms that allow multiple PDA clients to simultaneously transmit large databases to and from a server in an efficient and timely manner would be advantageous.

### BRIEF SUMMARY OF THE INVENTION

The foregoing problems with the prior state of the art are overcome by the principles of the present invention, which are directed towards methods, systems, computer program products for simultaneous transfer of database updates between multiple clients and a server. A first client and a server establish a first connection. The first client requests a client database update from the server. The server accessing a first data subset in a server database, the first data subset corresponding to the first client. The server initiates transfer of the first data subset to the first client over the first connection.

A second client and the server establish a second connection prior to the first connection being terminated. The second client requests a client database update from the server. The server accessing a second data subset in the server database, the second data subset corresponding to the second client. The server initiates transfer of the second data subset to the second client over the second connection. The server transfers at least a portion of the first data subset and at least a portion of the second data subset essentially simultaneously.

The first client receives the first data subset formatted for use at the first client. The first client replaces the first client database with the first data subset, in response to receiving the first data subset. Similarly, the second client receives the second data subset formatted for use at the second client. The second client replaces the second client database with the second data subset, in response to receiving the second data subset.

In some embodiments, a client receives a client database update (e.g., from an input device). The client sends the client database update to the server. The client empties a corresponding client database subsequent to sending the client database update in preparation for receiving updated client data. The client receives an updated client data subset from the server. The client stores the updated client data subset in the client database.

These and other features of the present invention will become more fully apparent from the following description and appended claims, or may be learned by the practice of the invention as set forth hereinafter.

### BRIEF DESCRIPTION OF THE DRAWINGS

In order that the manner in which the above recited and other advantages and objects of embodiments of the invention are obtained, a more particular description of the invention briefly described above will be rendered by reference to specific embodiments thereof that are illustrated in the appended drawings. Understanding that these drawing depict only typical embodiments of the invention and are not therefore to be considered to be limiting of its scope, the invention will be described and explained with additional specificity and detail through the use of the accompanying drawings in which:

FIG. 1A illustrates an example computer architecture for multiple computer device clients to simultaneously transfer data to and from a server.

FIG. 1B illustrates an example logical view of different subsets of a database.

FIG. 2 illustrates a flow chart of an example method for simultaneous transfer of data between multiple clients and a server.

FIG. 3 illustrates a flow chart of an example method for efficiently updating a client.

FIG. 4 illustrates a suitable operating environment for the principles of the present invention.

FIG. 5 illustrates a suitable operating environment for the principles of the present invention.

### DETAILED DESCRIPTION OF THE INVENTION

The present invention relates to simultaneous transfer of database updates between multiple clients and a server. A first client and a server establish a first connection. The first client requests a client database update from the server. The server accessing a first data subset in a server database, the first data subset corresponding to the first client. The server initiates transfer of the first data subset to the first client over the first connection.

A second client and the server establish a second connection prior to the first connection being terminated. The second client requests a client database update from the server. The server accessing a second data subset in the server database, the second data subset corresponding to the second client. The server initiates transfer of the second data subset to the second client over the second connection. The server transfers at least a portion of the first data subset and at least a portion of the second data subset essentially simultaneously.

The first client receives the first data subset formatted for use at the first client. The first client replaces the first client database with the first data subset, in response to receiving the first data subset. Similarly, the second client receives the second data subset formatted for use at the second client. The second client replaces the second client database with the second data subset, in response to receiving the second data subset.

In some embodiments, a client receives a client database update (e.g., from an input device). The client sends the client database update to the server. The client empties a corresponding client database subsequent to sending the client database update in preparation for receiving updated client data. The client receives an updated client data subset from the server. The client stores the updated client data subset in the client database.

Embodiments within the scope of the present invention include computer-readable media for carrying or having computer-executable instructions or data structures stored thereon. Such computer-readable media may be any available media, which is accessible by a general-purpose or special-purpose computer system. By way of example, and not limitation, such computer-readable media can comprise physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

In this description and in the following claims, a “network” is defined as one or more data links that enable the transport of electronic data between computer systems and/or modules. When information is transferred or provided over a network or another communications connection (either hardwired, wireless, or a combination of hardwired or wireless) to a computer system, the connection is properly viewed as a computer-readable medium. Thus, any such connection is properly termed a computer-readable medium. Combinations of the above should also be included within the scope of computer-readable media. Computer-executable instructions comprise, for example, instructions and data which cause a general-purpose computer system or special-purpose computer system to perform a certain function or group of functions. The computer executable instructions may be, for example, binaries, intermediate format instructions such as assembly language, or even source code.

In this description and in the following claims, a “computer system” is defined as one or more software modules, one or more hardware modules, or combinations thereof, that work together to perform operations on electronic data. For example, the definition of computer system includes the hardware components of a personal computer, as well as software modules, such as the operating system of the personal computer. The physical layout of the modules is not important. A computer system may include one or more computers coupled via a network. Likewise, a computer system may include a single physical device (such as a mobile phone or Personal Digital Assistant “PDA”) where internal modules (such as a memory and processor) work together to perform operations on electronic data.

After having reviewed this description, those skilled in the art will appreciate that the invention may be practiced in network computing environments with many different types of computer system configurations, including, personal computers, laptop computers, hand-held devices, multi-processor systems, microprocessor-based or programmable consumer electronics, network PCs, minicomputers, mainframe computers, mobile telephones, PDAs, pagers, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

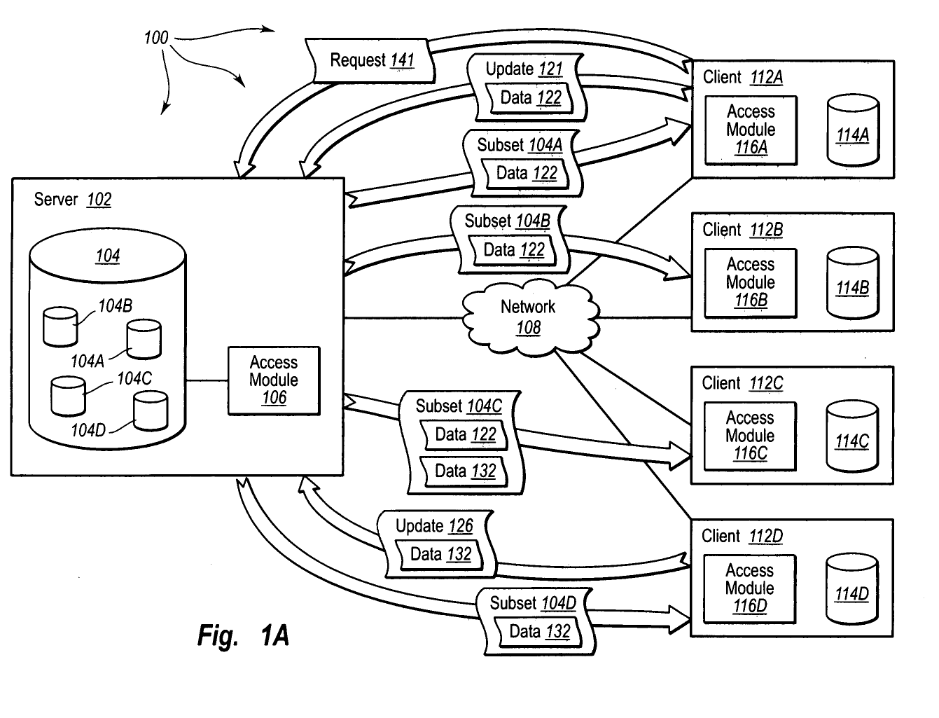

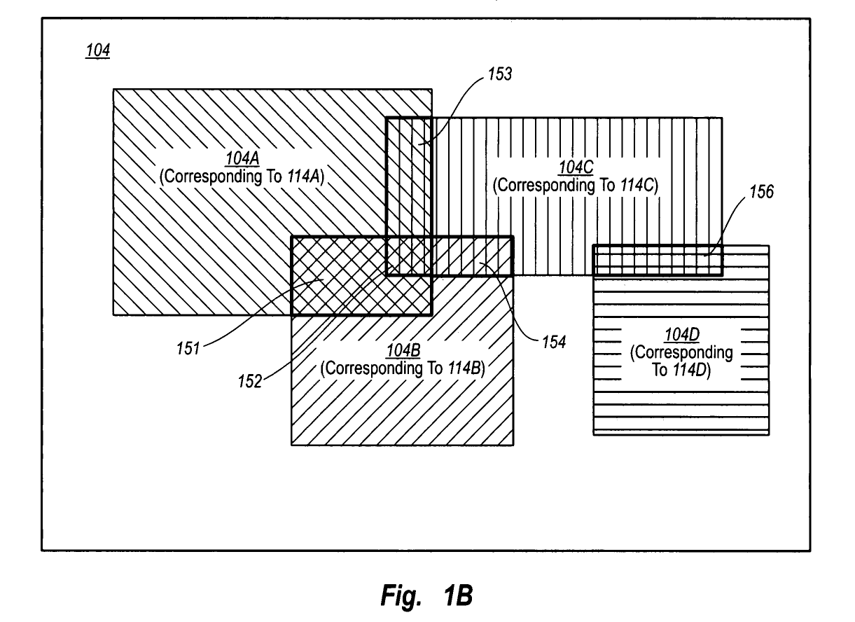

FIG. 1A illustrates an example computer architecture 100 for multiple computer device clients to simultaneously transfer data to and from a server. As depicted in FIG. 1A, computer architecture 100 includes a network 108 that facilitates communication between a server 102 and clients 112A, 112B, 112C and 112D. Network 108 can be virtually any type of network, such as, for example, a Local Area Network (“WAN”), a Personal Area Network (“PAN”), a Home Area Network (“HAN”), a Wide Area Network (“WAN”), or even the Internet.

Computer systems connected to network 108 can receive data from and send data to other computer systems that are also connected to 108. Accordingly, server 102, and clients 112A, 112B, 112C and 112D, as well as other connected computer systems (not shown), can exchange data (e.g., included in Internet Protocol (“IP”) datagrams and in accordance with other higher layer protocols that utilize IP datagrams, such as, Transmission Control Protocol (“TCP”), Hypertext Transfer Protocol (“HTTP”), etc.) over networks 108. For example, each of server 102 and clients 112A, 112B, 112C and 112D can include database applications configured to transfer and process data.

Server 102 can be a general-purpose or special-purpose computer system. Server 102 includes database 104 and access module 106. Generally, access module 106 is configured to access, update, and transfer data values stored in database 104. Clients 112A, 112B, 112C and 112D can general-purpose or special-purpose computer systems, such as, for example, personal digital assistants (“PDAs”) or other hand held devices. Clients 112A, 112B, 112C and 112D include databases 114A, 114B, 114C and 114D respectively. Generally, access modules 116A, 116C, 116B, and 116D are configured to access, update, and transfer data values stored in databases 114A, 114B, 114C and 114D respectively. Access modules 116A through 116D and 106 facilitate the transfer of data between databases 114A through 114D and 104 respectively.

Each of databases 114A, 114B, 114C and 114D can correspond to different data subsets of data (e.g., a subset of name/value pairs) from database 104. For example, data subsets 104A through 104D can correspond to databases 114A through 114D respectively. Each data subset 104A through 104D (and thus also each of corresponding databases 114A through 114D respectively) can include at least some data that differs from data in other data subsets (or from data in other client databases). For example, data subset 104C (and corresponding client database 114C) can include at least some data that differs from data subsets 104A, 104B, and 104D (and corresponding client databases 114A, 114B, and 114D).

However, each data subset 104A through 104D (and thus also each of corresponding databases 114A through 114D respectively) can also include at least some data that overlaps with data in other data subsets (or in other client databases). For example, data subset 104B (and corresponding client database 114B) can include at least some data that overlaps with data subset 104A (and corresponding client database 114A). Thus, each of the data subsets 104A through 104D (and corresponding client databases) can have some portions of data that differ from the other data subsets and corresponding client databases) and can have some portions of data and corresponding client databases) that are the same as other data subsets and corresponding client databases). For example, data subset 104B can be completely different from data subset 104D, differ from data subset 104A but share a first overlapping portion of data with data subset 104A, and differ from data subset 104C but share a second different overlapping portion of data with data subset 104C.

FIG. 1B illustrates an example logical view of data subsets 104A through 104D (corresponding to client databases 114A through 114D respectively) from database 104. It should be understood that FIG. 11B is a logical view and that the data configuration of database 104 can be such that data is integrated within database 104. As depicted, data subset 104A and data subset 104B each include overlapping portion 151. Data subset 104A and data subset 104C each include overlapping portion 153. Data subset 104B and data subset 104C each include overlapping portion 154. Data subset 104A, data subset 104B, and data subset 104C each include data subset 152. Data subset 104C and data subset 104D each include overlapping portion 156. Each of the overlapping portions 151, 152, 153, 154, and 156 represents data (e.g., one or more name/value pairs) that are shared between the corresponding data subsets.

Thus, it may be that a plurality of different clients is configured to change overlapping portions data stored in database 114. For example, client 112A, client 112B, and client 112C can each be configured to change data in overlapping portion 152. Further, it may also be that the database applications implemented at clients 112A through 112D are real-time or near real-time applications. Accordingly, when one client facilitates a change to an overlapping portion, the change can be propagated to one or more other clients. For example, if client 112C changes data in overlapping portion 156, the change can be propagated to client 112D.

As a result of data entry or communication with other devices, different clients from among clients 112A through 112D can receive updated data (e.g., updated values for a name/value pairs) for different portions of data at different times. For example, client 112B can receive an update to a first data value in database 114B and client 112D can receive an update to a second different data value in database 114D. Thus it may be that after a client updates a data value, database 104 (as well as other client databases including overlapping data portions) does not include the most recent data. Accordingly, from time to time, one or more of clients 112A through 112D can transmit updated data values to database 104. Transmitting data to database 104 can be indicated, for example, when users of clients 112A through 112D modify data in databases 114A through 114D.

Server 102 can receive updated data values and process data sets (e.g., to corresponding update database 104) as appropriate. Thus, any conflicts between data from different clients are resolved at server 102, subsequent to the data being received from the different clients. Accordingly, (potentially limited) client resources are not consumed for data set processing or conflict resolution. Server 102 can update any data subset (e.g., from 104A through 104D) that references a received updated value.

After database 104 is updated, it may be that one or more of databases 114A -114D do not include more recent data subsets (e.g., in overlapping portions). For example, updating database 104 in response to an updated value at database 114A can cause one or more of databases 114B-114D to become outdated. Thus, from time to time, server 104 can send updated data subsets to corresponding clients. For example, in response to receiving an update to overlapping portion 151 from client 114A, server 104 can send an updated data subset 104B to client 114B.

Clients 112A through 112D can receive updated data values and correspondingly update (e.g., completely overwrite) client databases 114A through 114D respectively with received data values. Receiving data from database 104 can be indicated, for example, when modifications to database 104 cause data in an overlapping portion to change.

In some embodiments, a client device (e.g., one or more of clients 112A through 112D) creates a wired or wireless connection to a server (server 102). Clients use a protocol, such as, for example, TCP/IP, to establish a connection with the server at a server name or network (e.g., IP) address. The server is configured such that a plurality clients can simultaneous connect to the server.

Clients send zero or more database files (e.g., blocks of database-update instructions) to the server. Subsequent to sending database files, clients can empty corresponding databases. For example, client 112B can empty database 114B after sending database files to server 102. The server receives database updates and appends or updates a corresponding database. For example, in response to database files from client 114B, serer 102 can update data subsets 114A, 114B, and 114C (since overlapping portion 152 is included in each of the data subsets 114A, 114B, and 114C.

The server can resolve any data conflicts, process data sets, and identify most recent data for overlapping portions. The server sends zero or more database files (e.g., blocks of database-update instructions) to the clients. Clients receive the server updates and replace corresponding database values. For example, client 112C can completely overwrite data in database 114C with data from a server update to data subset 104C.

In other embodiments, fully formatted and complete files are transferred from the server to clients. The files are formatted and completed at the server and then sent to clients. Clients receive and store the formatted and completed files. Since the files are already formatted and completed, limited, if any, client processing occurs to further prepare the files for use.

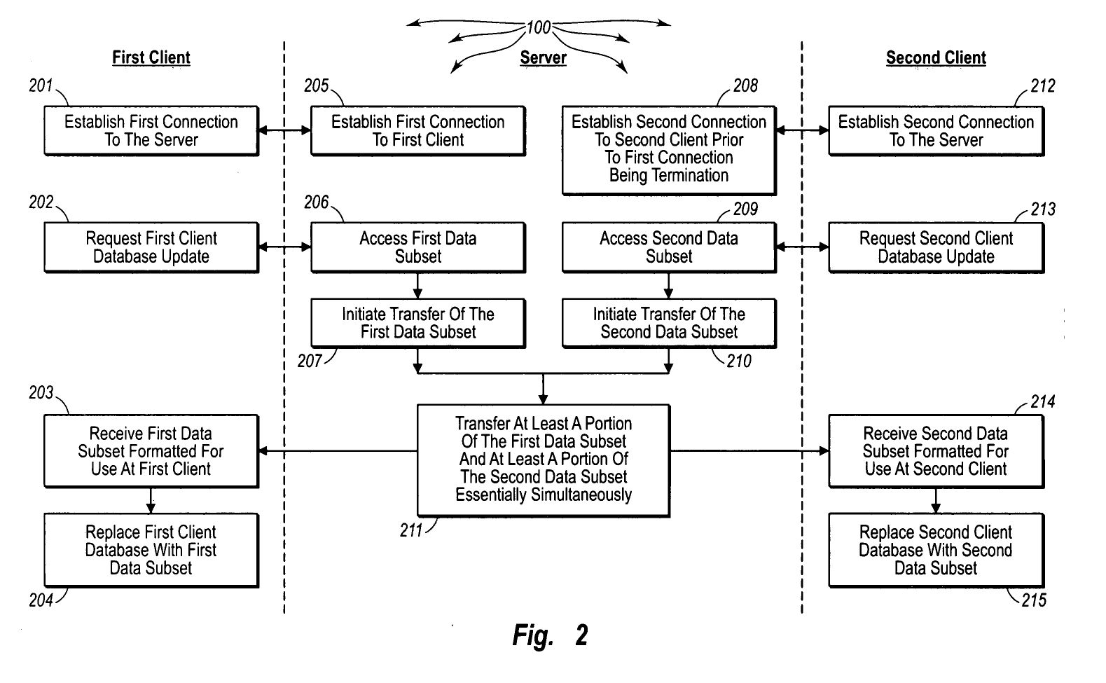

FIG. 2 illustrates a flow chart of an example method 200 for multiple clients to simultaneously transfer data to and from a server. Method 200 will be described with respect to the modules and data in computer architecture 100 and the logical view of data subsets 104A through 104D.

Method 200 includes an act of establishing a first connection to a server (act 201). For example, client 112A can establish a TCP connection with server 102. Method 200 includes an act of establishing a first connection to a first client (act 205). For example, server 102 can establish a TCP connection to client 112A.

Method 200 includes an act of requesting a first client database update (act 202). For example, client 112A can request an update for database 114A from server 102. A client database update request can be an express request. For example, client 112A can send request 141 (e.g., over an established TCP connection) to server 102.

Alternately, a request can result from a previously established context between a client and a server. For example, it may be that client 112A sends update 121 (e.g., over an established TCP connection), containing data 122, to server 102. Client 112A may be configured to empty database 114A after sending client updates, such as, for example, update 121. Server 102 may be configured to interpret a client update as a request for client database update. Accordingly, server 102 can interpret update 121 as a request for an update to database 114A.

Method 200 includes an act of accessing a first data subset (act 206). For example, in response to a request from client 112A, server 102 can access data subset 104A. Server 102 can process and format data updates, such as, for example, update 121, into data subset 104A. Data subset 104A can be processed and formatted such that data subset 104A is ready for use at client 112A with little, if any, further processing at client 112A. Alternately, server 102 can formulate database update instructions that instruct client 112A how to update database 114A.

Method 200 includes an act of initiating transfer of the first data subset (act 207). For example, server 102 can initiate transfer of subset 104A, including data 122, to client 112A (e.g., over an established TCP connection). Alternately, server 102 can initiate transfer of formulated database update instructions that instruct client 112A how to update database 114A.

Method 200 includes an act of establishing a second connection to the server (act 212). For example, client 112B can establish a TCP connection with server 102. Method 200 includes an act of establishing a second connection to a second client prior to the first connection being terminated (act 208). For example, server 102 can establish a TCP connection to client 112B prior to a TCP connection between client 112A and sever 102 being terminated.

Method 200 includes an act of requesting a second client database update (act 213). For example, client 112B can request an update for database 114B from server 102. A client database update request from client 112B can be an express request or can result form an established context between client 112B and server 102. For example, client 112B can send an express request or a data update (over an established TCP connection) to server 102.

Method 200 includes an act of accessing a second data subset (act 209). For example, in response to a request from client 112B, server 102 can access data subset 104B. Server 102 can process and format data updates, such as, for example, update 121, into data subset 104B. Data subset 104B can be processed and formatted such that data subset 104B is ready for use at client 112B with little, if any, further processing at client 112B. Referring to FIG. 11B briefly, it may be that data 122 (from update 121) is included in overlapping portion 151. Thus, server 102 can include data 122 in data subset 104B such that database 114B receives more recent data. Alternately, server 102 can formulate database update instructions that instruct client 112B how to update database 114B.

Method 200 includes an act of initiating transfer of the first data subset (act 210). For example, server 102 can initiate transfer of subset 104B, including data 122, to client 112B (e.g., over an established TCP connection). Alternately, server 102 can initiate transfer of formulated database update instructions that instruct client 1121B how to update database 114B.

Method 200 includes an act of transferring at least a portion of the first data subset and at least a portion of the second data subset simultaneously (act 211). For example, portions of subset 104B can be transferred to client 1121B (over an established TCP connection), while portions of subset 104A are being transferred to client 112B (over another established TCP connection).

Method 200 includes an act of receiving a first data subset formatted for use at the first client (act 203). For example, client 112A can receive subset 104A from server 102. Method 200 includes an act of replacing the first client database with the first data set (act 204). For example, client 112A can replace (potentially all) values in 114A with values in subset 104A. Alternately, client 112A can receive database update instructions and can update database 114A in accordance with the received database update instructions. The first client can terminate the first connection to the server after a first data subset and/or database update instructions are received. For example, client 112A can terminated a TCP connection to server 102 after received subset 104A.

Method 200 includes an act of receiving a second data subset formatted for use at the second client (act 214). For example, client 112A can receive subset 104B from server 102. Method 200 includes an act of replacing the second client database with the second data set (act 215). For example, client 112B can replace (potentially all) values in 114B with values in subset 104B. Alternately, client 112B can receive database update instructions and can update database 114B in accordance with the received database update instructions. The second client can terminate the second connection to the server after a second data subset and/or database update instructions are received. For example, client 112B can terminated a TCP connection to server 102 after received subset 104B.

In some embodiments, a plurality of connections (e.g., a first and second) are established between a single client and a server.

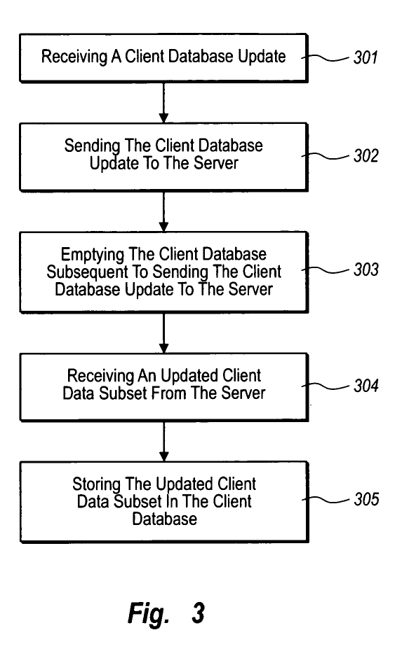

FIG. 3 illustrates a flow chart of an example method 300 for efficiently updating a client. Method 300 will be described with respect to the modules and data in computer architecture 100 and the logical view of data subsets 104A through 104D.

Method 300 includes an act of receiving a client database update (act 301). For example, client 112D can receive an update to database 114D. A client database update can result from the acquisition of data through an input device, such as, for example, a keypad, optical scanner, etc. For example, a PDA equipped with a scanner may scan a received crate of a specified item causing a client database (in the PDA) to update a quantity in stock value for the specified item.

Method 300 includes an act of sending the client database update to the server (act 302). For example, client 112D can send update 126, including data 132, to server 102. Client 112D can establish a connection (e.g., a TCP connection) to server 102 prior to sending update 126. Method 300 includes an act of emptying the client database subsequent to sending the client database update to the server (act 303). For example, client 112D can empty database 114D subsequent to sending update 126 to server 102 and in preparation for receiving updated client data from server 102. Emptying a client database can include removing a plurality of values from the client database.

Method 300 includes an act of receiving an update client data subset from the server (act 304). For example, client 112D can receive subset 104D, including data 132, from server 102. Subset 104D can be a data subset that was processed and formatted such that data subset 104D is ready for use at client 112D.

An updated client data subset can include updates from a plurality of different clients. For example, it may be that server 102 receives both update 121 and update 126. Referring briefly to FIG. 1B, since data subsets 104A and 104D both overlap with data subset 104C (at overlapping portions 153 and 156), server 102 can determine that both data 122 and data 132 are to be included in data subset 104C. Accordingly, in response to an update request form client 112C, subset 104C, including data 122 and data 132, can be sent to client 112C.

Method 300 includes an act of storing the updated client data subset in the client database (act 305). For example, client 112A can store subset 104D in database 114D. Since subset 104D is processed and formatted for client 112D, subset 104D is ready for use at client 112D, with little, if any, further processing at client 112D. Accordingly, a client database can be updated to reflect modifications to a corresponding data subset, wherein the corresponding data subset overwrites the client database without performing any checks related to the integrity of the data such that the database can be updated more efficiently.

In some embodiments, clients send updated client data to a server in response to some specified event. The specified event can be, for example, the expiration of a client-specified time interval after reception of a current data subset. Likewise, the specified event could be the manual request by the user of a client.

As depicted in computer architecture 100, four clients 112A through 112D are connected to network 108. However, it should be understood that much larger pluralities of clients can simultaneously establishing connections to and exchanging data with a server to facilitate database updates. Thus, from time to time, a server can simultaneously receive (wired or wireless) updates from different clients. Updates can include different updated values for the same data, such as, for example, two different values for the same name value pair. The server (e.g., server 102) can resolve such conflicts locally such that the resources of clients are not consumed to resolve the conflicts.

In some environments, client databases (e.g., 114A through 114D) are smaller than a server database (e.g., database 104). Similarly, clients (e.g., 112A through 112D) can have limited memory and processing resources when compared to a corresponding server (e.g., 102). For example, a PDA may have significantly reduced resources compared to the resources of a desktop personal computer. Thus, in some embodiments, data processing occurs at a server having increased resources such that limited resources at clients are conserved. Further, embodiments of the present invention can utilize protocols (e.g., TCP) that do not limit the size of databases that can be transferred.

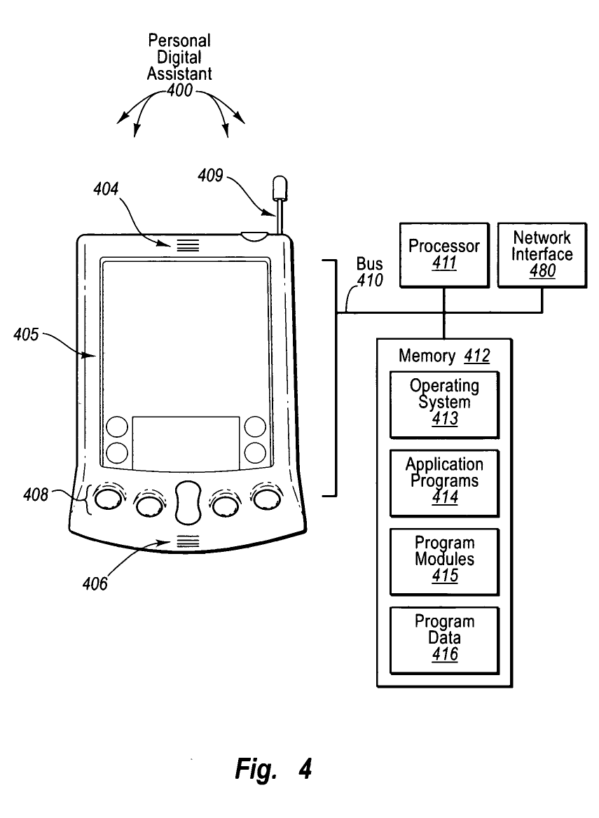

FIG. 4 and the following discussion are intended to provide a brief, general description of a suitable computing environment in which the invention may be implemented. Although not required, the invention will be described in the general context of computer-executable instructions, such as program modules, being executed by computer systems. Generally, program modules include routines, programs, objects, components, data structures, and the like, which perform particular tasks or implement particular abstract data types. Computer-executable instructions, associated data structures, and program modules represent examples of the program code means for executing acts of the methods disclosed herein.

With reference to FIG. 4, a suitable operating environment for a client includes a general-purpose computer system in the form of personal digital assistant 400. Personal digital assistant 400 includes a speaker 404 for presenting audio information (e.g., spoken words) to the user, a display 405 for presenting visual information to the user, a microphone 406 for inputting audio information (e.g., spoken words) into personal digital assistant 400, and navigation control buttons 408 that assist the user in navigating through various entries and options listed on display 405. Although not required, personal digital assistant 400 may also have an antenna 409.

The unseen features of the personal digital assistant 400 may allow for complex and flexible general-purpose processing capabilities. For example, the personal digital assistant 400 also includes processor 411, network interface 480, and memory 412 that are connected to each other and to speaker 404, display 405, navigation controls 408, dialing controls 407, microphone 406, and antenna 409 when appropriate, via system bus 410. The memory 412 generally represents a wide variety of volatile and/or non-volatile memories and may include types of memory previously discussed. However, the particular type of memory used in the personal digital assistant 400 is not important to the present invention. Program code means comprising one or more program modules may be stored in memory 412. The one or more program modules may include an operating system 413, one or more application programs 414, program modules 415, and program data 416.

Personal digital assistant 400 is connectable to networks, such as, for example, an office-wide or enterprise-wide computer network, an intranet, and/or the Internet. Personal digital assistant 400 can wirelessly exchange data with external sources, such as, for example, remote computer systems and/or application databases over such a network. Personal digital assistant 400 includes network interface 480 that can, when appropriate, interoperate with antenna 409 to receive data from external sources and/or transmit data to external sources. For example, personal digital assistant 400 can exchange data with a server as well as other computer systems. Personal digital assistant 400 can also include an integrated or external (e.g., a scan gun) scanner, such as, for example, to scan bar codes.

While FIG. 4 represents a suitable operating environment for the present invention, the principles of the present invention may be employed in any system that is capable of, with suitable modification if necessary, implementing the principles of the present invention. The environment illustrated in FIG. 4 is illustrative only and by no means represents even a small portion of the wide variety of environments in which the principles of the present invention may be implemented.

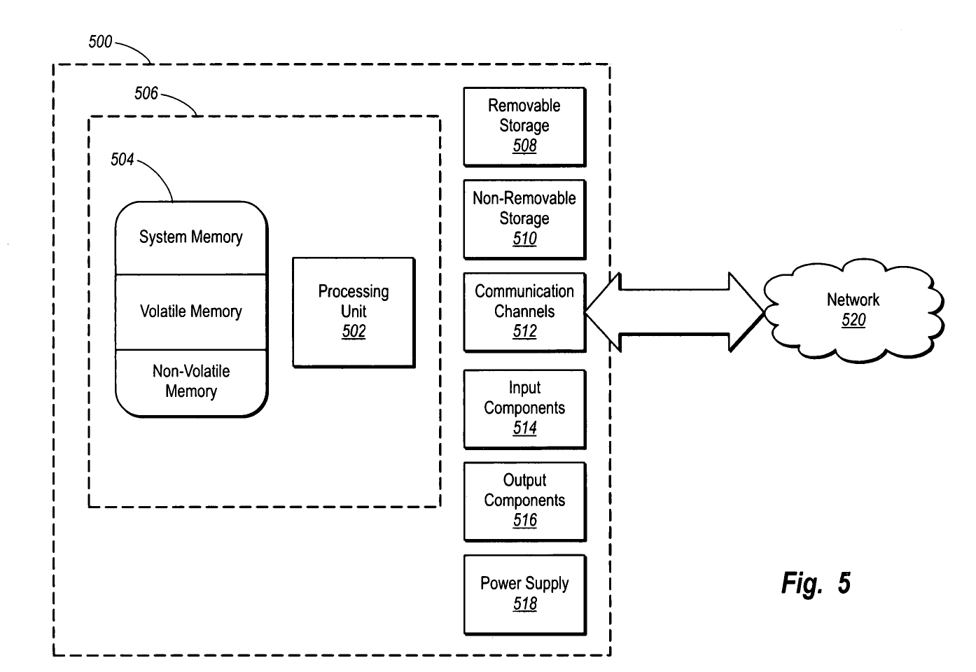

FIG. 5 depicts a schematic diagram of a computer system 500. Server 102 can include one or more of the components included in computer system 500. For descriptive purposes, the depicted computer system is only one example of a suitable environment and is not intended to suggest any limitation as to the scope of use or functionality of the invention. Neither should the computer systems be interpreted as having any dependency nor requirement relating to any one or combination of components illustrated in FIG. 5.

In some basic configurations, computer system 500 includes at least one processing unit 502 and memory 504. The memory 504 may be volatile (such as RAM), non-volatile (such as ROM, flash memory, etc.), or some combination of the two. One basic configuration is illustrated in FIG. 5 by the dashed line 506.

Included storage media devices may have additional features and functionality. For example, they may include additional storage (removable and non-removable) including, but not limited to, PCMCIA cards, magnetic and optical disks, and magnetic tape. Such additional storage is illustrated in FIG. 5 by removable storage 508 and non-removable storage 510. Computer-storage media include volatile and non-volatile, removable and non-removable media implemented in any method or technology for storage of information such as computer-readable instructions, data structures, program modules, or other data. Memory 504, removable storage 508, and non-removable storage 510 are all examples of computer-storage media. Computer-storage media include, but are not limited to, RAM, ROM, EEPROM, flash memory, other memory technology, CD-ROM, digital versatile disks, other optical storage, magnetic cassettes, magnetic tape, magnetic disk storage, other magnetic storage devices, and any other media that can be used to store the desired information and that can be accessed by the computer system.

Computer system 500 may also contain communication channels 512 that allow the host to communicate with other systems and devices over a network 520. Communication channels 512 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

The computer system 500 may also have input components 514 such as a keyboard, mouse, pen, a voice-input component, a touch-input device, and so forth. Output components 516 include screen displays, speakers, printer, etc., and rendering modules (often called “adapters”) for driving them. The computer system 500 has a power supply 518. All these components are well known in the art and need not be discussed at length here.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired secured by United States Letters Patent is:

1. At a server that is network connectable to a plurality of clients having limited system resources, a method for the server to simultaneously exchange data with at least two clients such that the clients can access and transfer data updates in a resource efficient manner, the method comprising:
an act of establishing a first connection to a first PDA;
an act of accessing a first data subset in a server database, the first data subset corresponding to the first PDA;
an act of initiating transfer of the first data subset to the first PDA over the first connection, the first data subset for updating a first client database at the first PDA;
an act of establishing a second connection to a second PDA, prior to the first connection being terminated;
an act of accessing a second data subset in the server database, the second data subset corresponding to the second PDA;
an act of initiating transfer of the second data subset to the second PDA over the second connection, the second data subset for updating a second client database at the second PDA; and
an act of transferring at least a portion of the first data subset and at least a portion of the second data subset essentially simultaneously.

2. The method as recited in claim 1, wherein the act of establishing a first connection to a first PDA comprises an act for establishing a first connection to a first PDA that is wirelessly connected to the network.

3. The method as recited in claim 1, wherein the act of establishing a first connection to a first client comprises an act for establishing a TCP connection to the first client.

4. The method as recited in claim 1, wherein the act of accessing a first data subset in a server database comprises an act of accessing a data subset that overlaps with one or more other data subsets.

5. The method as recited in claim 1, wherein the act of accessing a first data subset in a server database comprises an act of accessing a data subset including a data value that was updated by a different client.

6. The method as recited in claim 1, wherein act of initiating transfer of the first data subset to the first client over the first connection comprises an act of initiating transfer of database-update instructions to the first client.

7. The method as recited in claim 1, wherein act of initiating transfer of the first data subset to the first client over the first connection comprises an act of initiating transfer of the first data subset over a TCP connection.

8. The method as recited in claim 1, wherein act of initiating transfer of the first data subset to the first client over the first connection comprises an act of initiating transfer of processed data that has been formatted for use at the first client.

9. The method as recited in claim 1, wherein the act of establishing a second connection to a second client comprises an act for establishing a second connection to a PDA.

10. The method as recited in claim 1, wherein the act of establishing a first connection to a first client comprises an act for establishing a TCP connection to the second client.

11. The method as recited in claim 1, wherein the act of accessing a second data subset in a server database comprises an act of accessing a data subset that overlaps with one or more other data subsets.

12. The method as recited in claim 1, wherein the act of accessing a second data subset in a server database comprises an act of accessing a data subset including a data value that was updated by a different client.

13. The method as recited in claim 1, wherein act of initiating transfer of the second data subset to the second client over the second connection comprises an act of initiating transfer of database-update instructions to the second client.

14. The method as recited in claim 1, wherein act of initiating transfer of the second data subset to the second client over the second connection comprises an act of initiating transfer of the second data subset over a TCP connection.

15. The method as recited in claim 1, wherein act of initiating transfer of the second data subset to the second client over the second connection comprises an act of initiating transfer of processed data that has been formatted for use at the second client.

16. A method as recited in claim 1, further comprising:
an act of formatting the first data set for use at the first client such that the resources of the first client can be freed up for other processing.

17. The method as recited in claim 1, further comprising:
an act of formatting the second data set for use at the second client such that the resources of the second client can be freed up for other processing.

18. The method as recited in claim 1, wherein the act of transferring at least a portion of the first data subset and at least a portion of the second data subset essentially simultaneously comprises an act of transferring a portion of the first data subset over a first TCP connection and simultaneously transferring a portion of the second data subset over a second TCP connection such that the first and second clients are updated simultaneously.

19. At a client having limited system resources, the client being network connectable to a network along with one or more other clients and a server, a method for efficiently updating a client database at the client such that some of the client's system memory is conserved, the method comprising:
an act of establishing a connection to the server;
an act of requesting a client database update from the server;
an act of receiving a current data subset for the client from the server, the current data subset being a subset of data contained in a server database at the server, the current data subset containing one or more current data values from the server database and being formatted for use at the client; and
an act of automatically replacing the client database with the current data subset, in response to receiving the current data subset.

20. The method as recited in claim 19, further comprising:
an act of detecting that a portion of the current data subset has been modified, subsequent to overwriting the prior data values; and
an act of transmitting the modified portion of the current data subset back to the server, in response to a specified event.

21. A method as defined in claims 20, further comprising an act of establishing a second connection to the server prior to transmitting the modified portion of the current data subset back to the server.

22. A method as defined in claims 20, wherein the modifications made to the current data subset on the client are transmitted back to the server as blocks of database update instructions.

23. A method as defined in claim 20, wherein the act of requesting a current data subset from the server comprises the act of requesting a specified subset of the database.

24. A method as defined in claim 19, wherein the act of automatically replacing the client database with the current data subset, in response to receiving the current data subset comprises an act of updating the client database to reflect the modifications made to the data included in the received current data subset, wherein the modified data overwrites the corresponding data in the client database without performing any checks related to the integrity of the data such that the database can be updated more efficiently.

25. At a client having limited system resources, the client being network connectable to a network along with one or more other clients and a server, a method for efficiently updating a client database at the client such that some of the client's system memory is conserved, the method comprising:
an act of receiving a client database update;
an act of sending the client database update to the server;
an act of emptying the client database subsequent to sending the client database update in preparation for receiving updated client data;
an act of receiving an updated client data subset from the server;
an act of storing the updated client data subset in the client database.

26. The method as recited in claim 25, wherein the act of receiving a client database update comprises an act of receiving a client database update through an input device at a PDA.

27. The method as recited in claim 25, wherein the act of sending the client database update to the server comprises an act of establishing a TCP connection with the server.

28. The method as recited in claim 25, wherein the act of emptying the client database subsequent to sending the client database update in preparation for receiving updated client data comprises an act of removing a plurality of values from the client database.

29. The method as recited in claim 25, wherein the act of receiving an updated client data subset from the server comprises an act of receiving database-update instructions.

30. A computer program product for use at a server that is network connectable to a plurality of clients having limited system resources, the computer program product for implementing a method for the server to simultaneously exchange data with at least two clients such that the clients can access and transfer data updates in a resource efficient manner, the computer program product comprising one or more computer-readable media having stored thereon computer-executable instructions that, when executed by a processor, cause the server to perform the following:
establish a first connection to a first client;
access a first data subset in a server database, the first data subset corresponding to the first client;
initiate transfer of the first data subset to the first client over the first connection, the first data subset for updating a first client database at the first client;
establish a second connection to a second client, prior to the first connection being terminated;
access a second data subset in the server database, the second data subset corresponding to the second client;
initiate transfer of the second data subset to the second client over the second connection, the second data subset for updating a second client database at the second client; and
transfer at least a portion of the first data subset and at least a portion of the second data subset essentially simultaneously.

31. The computer program product as recited in claim 30, further computer-executable-instructions that, when executed by a processor, cause the server to format the first data set for use at the first client such that the resources of the first client can be freed up for other processing.

32. The computer program product as recited in claim 30, further computer-executable-instructions that, when executed by a processor, cause the server to format the second data set for use at the second client such that the resources of the second client can be freed up for other processing.

33. The computer program product as recited in claim 30, wherein computer-executable-instructions that, when executed, cause the server to transfer at least a portion of the first data subset and at least a portion of the second data subset essentially simultaneously comprise computer-executable-instructions that, when executed, cause the server to transfer a portion of the first data subset over a first TCP connection and simultaneously transfer a portion of the second data subset over a second TCP connection such that the first and second clients are updated simultaneously.

34. A computer program, product for use at a client having limited system resources, the client being network connectable to a network along with one or more other clients and a server, the computer program product for implementing a method for efficiently updating a client database at the client such that some of client's system memory is conserved, the computer program product comprising one or more computer-readable media having stored thereon computer-executable instructions that, when executed by a processor, cause the client to perform the following establish a connection to the server;
request a client database update from the server;
receive a current data subset for the client from the server, the current data subset being a subset of data contained in a server database at the server, the current data subset containing one or more current data values from the server database and being formatted for use at the client; and
replace the client database with the current data subset, in response to receiving the current data subset.

35. The computer program product as recited in claim 34, further computer-executable-instructions that, when executed by a processor, cause the client to perform the following:
detect that a portion of the current data subset has been modified, subsequent to overwriting the prior data values; and
transmit the modified portion of the current data subset back to the server, in response to a specified event.

36. The computer program product as recited in claim 34, further computer-executable-instructions that, when executed by a processor, cause the client to establish a second connection to the server prior to transmitting the modified portion of the current data subset back to the server.

37. A computer program, product for use at a client having limited system resources, the client being network connectable to a network along with one or more other clients and a server, the computer program product for implementing a method for efficiently updating a client database at the client such that some of the client's system memory is conserved, the computer program product comprising one or more computer-readable media having stored thereon computer-executable instructions that, when executed by a processor, cause the client to perform the following receive a client database update;
send the client database update to the server;
empty the client database subsequent to sending the client database update in preparation for receiving updated client data;
receive an updated client data subset from the server;
store the updated client data subset in the client database.

38. The computer program product as recited in claim 37, wherein computer-executable-instructions that, when executed, cause the client to receive a client database update comprise computer-executable-instructions that, when executed, cause the client to receive a client database update through an input device at a PDA.

39. The computer program product as recited in claim 37, wherein computer-executable-instructions that, when executed, cause the client to send the client database update to the server comprise computer-executable-instructions that, when executed, cause the client to establish a TCP connection with the server.

40. The computer program product as recited in claim 37, wherein computer-executable-instructions that, when executed, cause the client to empty the client database subsequent to sending the client database update in preparation for receiving updated client data comprise computer-executable-instructions that, when executed, cause the client to remove a plurality of values from the client database.

41. The computer program product as recited in claim 37, wherein computer-executable-instructions that, when executed, cause the client to receive an updated client data subset from the server comprise computer-executable-instructions that, when executed, cause the client to receive database-update instructions.
